(19) United States
(12) Patent Application Publication
(10) Pub. No.: US 2025/0342469 A1
(43) Pub. Date: Nov. 6, 2025

(54) TRANSACTION EXECUTION METHODS, NODES, AND BLOCKCHAIN SYSTEMS

(71) Applicant: Ant Blockchain Technology (Shanghai) Co., Ltd., Shanghai (CN)

(72) Inventor: Youxian Tao, Hangzhou (CN)

(73) Assignee: Ant Blockchain Technology (Shanghai) Co., Ltd., Shanghai (CN)

(21) Appl. No.: 19/265,583

(22) Filed: Jul. 10, 2025

Related U.S. Application Data
(63) Continuation of application No. PCT/CN2023/135254, filed on Nov. 29, 2023.

(30) Foreign Application Priority Data
Jun. 30, 2023 (CN) 202310805096.8

(51) Int. Cl. G06Q 20/40; G06Q 20/38

(52) U.S. Cl. CPC G06Q 20/401; G06Q 20/389

(57) ABSTRACT

This specification provides transaction execution methods, nodes, and blockchain systems. The methods can be applied to a first node in a blockchain system, which includes a control process and N computing processes. In an example method, the control process acquires M transaction groups, where the M transaction groups are obtained by grouping transactions in a target block based on respective pre-execution read-write sets of the transactions, and M and N are positive integers. The control process acquires, when determining that there is another block that is in an execution phase, a pre-execution read-write set of a transaction in the another block, and sends a transaction group irrelevant to the acquired pre-execution read-write set, among the M transaction groups, to different computing processes in the N processes. A first computing process executes, when receiving any one of the M transaction groups, each transaction in the received transaction group.

### CROSS-REFERENCE TO RELATED APPLICATIONS

This application is a continuation of PCT Application No. PCT/CN2023/135254, filed on Nov. 29, 2023, which claims priority to Chinese Patent Application No. 202310805096.8, filed on Jun. 30, 2023, and each application is hereby incorporated by reference in its entirety.

### TECHNICAL FIELD

Embodiments of this specification relate to the field of blockchain technologies, and in particular, to transaction execution methods, nodes, and blockchain systems.

### BACKGROUND

Blockchain is a novel application mode of distributed data storage, peer-to-peer transmission, consensus mechanism, encryption algorithm, and other computer technologies. In a blockchain system, data blocks are sequentially connected in a time sequence and combined into a chain data structure, and distributed ledgers that cannot be tampered with or forged are cryptographically ensured. A user can participate in a transaction related to blockchain through a blockchain node. For example, a plurality of blockchain nodes corresponding to different users in the blockchain system can perform secure multi-party computation (SMPC) on private data of a certain node based on privacy technologies such as homomorphic encryption and zero-knowledge proof. For another example, transfers can be implemented between different user accounts based on a blockchain network. For another example, non-fungible tokens (NFTs) corresponding to digital collections such as digital paintings, digital avatars, and GIFs can also be issued based on the blockchain network, so that ownership of the digital collections carried by NFTs can be circulated among users of the blockchain network, thereby generating value corresponding to the digital collections.

### SUMMARY

This specification provides transaction execution methods, nodes, and blockchain systems.

Specifically, this specification is implemented using the following technical solutions:

According to a first aspect of embodiments of this specification, a transaction execution method is provided, and applied to a first node in a blockchain system, where the first node includes a control process and N computing processes, and the method includes: The control process acquires M transaction groups, where the M transaction groups are obtained by grouping a plurality of transactions in a target block based on respective pre-execution read-write sets of the plurality of transactions, and M and N are positive integers; the control process acquires, when determining that there is another block that is in an execution phase, a pre-execution read-write set of a transaction in the another block, and sends a transaction group irrelevant to the acquired pre-execution read-write set among the M transaction groups to different computing processes in the N processes; and a first computing process executes, when receiving any one of the M transaction groups, each transaction in the received transaction group.

According to a second aspect of embodiments of this specification, a transaction execution method is provided, and applied to a first node in a blockchain system, where the first node includes a control process and N computing processes, and the method includes: The control process determines a plurality of blocks, and acquires a transaction group corresponding to each of the blocks, where the transaction group is obtained by grouping a plurality of transactions in the corresponding block based on respective pre-execution read-write sets of the plurality of transactions; the control process generates a transaction group set, where transaction groups included in the transaction group set are from at least two of the plurality of blocks, and each of the transaction groups is irrelevant to a pre-execution read-write set corresponding to any other transaction group in the transaction group set, and sends the transaction groups in the transaction group set to different computing processes in the N processes, where N is a positive integer; and a first computing process executes, when receiving any transaction group, each transaction in the received transaction group.

According to a third aspect of embodiments of this specification, a first node in a blockchain system is provided, where the first node includes a control process and N computing processes, and the method includes: The control process is configured to acquire M transaction groups, where the M transaction groups are obtained by grouping a plurality of transactions in a target block based on respective pre-execution read-write sets of the plurality of transactions, and M and N are positive integers. The control process is configured to acquire, when determining that there is another block that is in an execution phase, a pre-execution read-write set of a transaction in the another block, and send a transaction group irrelevant to the acquired pre-execution read-write set among the M transaction groups to different computing processes in the N processes. A first computing process is configured to execute, when receiving any one of the M transaction groups, each transaction in the received transaction group.

According to a fourth aspect of embodiments of this specification, a first node in a blockchain system is provided, where the first node includes a control process and N computing processes. The control process is configured to determine a plurality of blocks, and acquire a transaction group corresponding to each of the blocks, where the transaction group is obtained by grouping a plurality of transactions in the corresponding block based on respective pre-execution read-write sets of the plurality of transactions. The control process is configured to generate a transaction group set, where transaction groups included in the transaction group set are from at least two of the plurality of blocks, and each of the transaction groups is irrelevant to a pre-execution read-write set corresponding to any other transaction group in the transaction group set; and send the transaction groups in the transaction group set to different computing processes in the N processes, where N is a positive integer. A first computing process is configured to execute, when receiving any transaction group, each transaction in the received transaction group.

According to a fifth aspect of embodiments of this specification, a blockchain system is provided and includes a first node, where the first node includes a control process and N computing processes. The control process is configured to acquire M transaction groups, where the M transaction groups are obtained by grouping a plurality of transactions in a target block based on respective pre-execution read-write sets of the plurality of transactions, and M and N are positive integers. The control process is configured to acquire, when determining that there is another block that is in an execution phase, a pre-execution read-write set of a transaction in the another block, and send a transaction group irrelevant to the acquired pre-execution read-write set among the M transaction groups to different computing processes in the N processes. A first computing process is configured to execute, when receiving any one of the M transaction groups, each transaction in the received transaction group.

According to a sixth aspect of embodiments of this specification, a blockchain system is provided and includes a first node, where the first node includes a control process and N computing processes. The control process is configured to determine a plurality of blocks, and acquire a transaction group corresponding to each of the blocks, where the transaction group is obtained by grouping a plurality of transactions in the corresponding block based on respective pre-execution read-write sets of the plurality of transactions. The control process is configured to generate a transaction group set, where transaction groups included in the transaction group set are from at least two of the plurality of blocks, and each of the transaction groups is irrelevant to a pre-execution read-write set corresponding to any other transaction group in the transaction group set; and send the transaction groups in the transaction group set to different computing processes in the N processes, where N is a positive integer. A first computing process is configured to execute, when receiving any transaction group, each transaction in the received transaction group.

According to a seventh aspect of embodiments of this specification, a computer-readable storage medium is provided and stores a computer program, where the program is executed by a processor to implement the steps of the method described in either the first aspect or the second aspect.

According to an eighth aspect of embodiments of this specification, a computer-readable storage medium is provided and stores computer instructions, where the instructions are executed by a processor to implement the steps of the method described in either the first aspect or the second aspect.

In the technical solutions provided in this specification, a transaction group of a target block is acquired, and a relationship between the transaction group and a pre-execution read-write set of a transaction between other blocks is obtained through comparison, to determine a transaction group to be sent to a computing process, so that transaction groups across a plurality of blocks can be independently executed, thereby improving processing efficiency of an execution pipeline for the plurality of blocks.

It should be understood that the foregoing general description and the following detailed description are merely examples and explanations, and should not limit this specification.

### BRIEF DESCRIPTION OF DRAWINGS

To describe the technical solutions in the embodiments of this specification more clearly, the following briefly describes the accompanying drawings needed for describing the embodiments. Clearly, the accompanying drawings in the following description are merely some embodiments of this specification, and a person of ordinary skill in the art can still derive other drawings from these accompanying drawings without creative efforts.

FIG. 1 is a schematic diagram illustrating a blockchain system, according to one or more example embodiments;

FIG. 2a to FIG. 2b are schematic diagrams illustrating a transaction execution flow in a blockchain node, according to one or more example embodiments;

FIG. 3 is a flowchart illustrating a transaction execution method, according to one or more example embodiments;

FIG. 4 is a schematic diagram illustrating a DAG graph of a plurality of transactions, according to one or more embodiments;

FIG. 5 is a schematic structural diagram illustrating any two nodes in a blockchain system, according to one or more example embodiments;

FIG. 6 is a schematic diagram illustrating parallel execution of transactions across inter-block groups, according to one or more example embodiments;

FIG. 7 is a flowchart illustrating another transaction execution method, according to one or more example embodiments;

FIG. 8 is a schematic structural diagram illustrating a first node in a blockchain system, according to one or more example embodiments; and

FIG. 9 is a schematic structural diagram illustrating a device, according to one or more example embodiments.

### DESCRIPTION OF EMBODIMENTS

Example embodiments will be described here in detail, and examples thereof are shown in the accompanying drawings. When the following descriptions relate to the accompanying drawings, unless specified otherwise, the same numbers in different accompanying drawings represent the same or similar elements. Implementations described in the following example embodiments do not represent all implementations consistent with this specification. On the contrary, the implementations are merely examples of apparatuses and methods that are consistent with some aspects of this specification.

It is worthwhile to note that, in some other embodiments, the steps of the corresponding method are not necessarily performed in the order shown and described in this specification. In some other embodiments, the method can include more or fewer steps than those described in this specification. In addition, a single step described in this specification may be decomposed into a plurality of steps in some other embodiments for description; and a plurality of steps described in this specification may be combined into a single step for description in some other embodiments. It should be understood that although terms “first”, “second”, “third”, etc. may be used in this specification to describe various types of information, the information is not limited to the terms. These terms are used merely to differentiate information of the same type. For example, without departing from the scope of this specification, first information may also be referred to as second information, and similarly, the second information may also be referred to as the first information. Depending on the context, for example, the word “if” used here can be explained as “while”, “when”, or “in response to determining”.

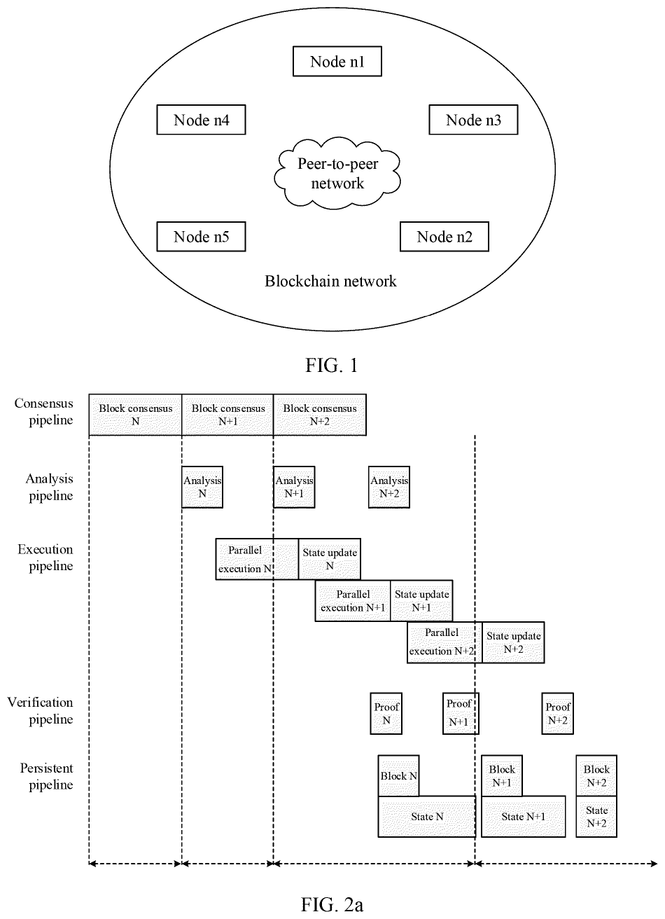

FIG. 1 is a schematic diagram illustrating a blockchain system, according to one or more example embodiments. As shown in FIG. 1, the blockchain system is a distributed network established by using a plurality of nodes, and includes a communication connection implemented at an application layer between any two nodes through a peer-to-peer (P2P) network. For example, any two nodes of node n1 to node n5 included in the blockchain system can implement a communication connection at the application layer through the P2P network. A decentralized (or multi-centralized) distributed ledger constructed by the blockchain system using a chain block structure is stored on each node (or most nodes, such as consensus nodes) in the distributed blockchain system. Therefore, the blockchain system needs to address the issue of consistency and correctness of data in respective ledgers on a plurality of decentralized (or multi-centralized) nodes. In view of this, each node of the blockchain system runs a blockchain program. Under the design of certain fault tolerance needs, a consensus mechanism is used to ensure that all honest nodes have the same transaction, thereby ensuring that all the honest nodes have consistent execution results for the same transaction, packaging the transaction into blocks and updating a world state based on the execution results of the same transaction. At present, mainstream consensus mechanisms include but are not limited to a proof of work (PoW), a proof of stake (POS), a practical Byzantine fault tolerance (PBFT) algorithm, a HoneyBadger Byzantine fault tolerance (HoneyBadger BFT) algorithm, etc.

A transaction in a blockchain field can refer to a task unit executed and recorded in a blockchain. The transaction usually includes a send field (From), a receive field (To), and a data field (Data). Transactions in the blockchain can include platform transactions and contract transactions. Platform transactions are mainly centered around platform account operations, including account creation, account transfer, account freezing, account unfreezing, asset issuance, and certificate deposit. Contract transactions are mainly centered around contract execution operations, including contract deployment, contract calling, contract upgrading, etc.

For example, in a case that the transaction is a transfer transaction, the From field indicates an address of an account that initiates the transaction (that is, initiates a transfer task to another account), the To field indicates an address of an account that receives the transaction (that is, receives the transfer), and the Data field includes a transfer amount. In a case that the transaction is a contract calling transaction, the From field indicates an address of an account that initiates the transaction, the To field indicates an address of an account of a contract called by the transaction, and the Data field includes data such as a name of a function in the called contract and parameters passed to the function, so as to acquire code of the function from the blockchain and execute the code of the function during execution of the transaction.

Accounts in the blockchain can usually be divided into two types: contract accounts, which store executed smart contract code and values of states in the smart contract code and can usually only be called and activated by an externally owned account; and externally owned accounts, namely, accounts of blockchain users.

Smart contracts in the blockchain are contracts that can be triggered by transactions to be executed in the blockchain system. Smart contracts can be described in the form of code. Calling a smart contract in the blockchain is initiating a transaction pointing to a smart contract address, so that all nodes in the blockchain network run smart contract code in a distributed manner. It is worthwhile to note that, in addition to being created by a user, the smart contract can also be set in a genesis block by the system. Such a contract is usually referred to as a genesis contract. Usually, some data structures, parameters, attributes, and methods of the blockchain can be set in the genesis contract. In addition, an account with system administrator permission can create a system-level contract or modify a system-level contract (briefly referred to as a system contract). The system contract can be used for adding data structures of data of different services to the blockchain.

In a contract deployment scenario, for example, Bob sends a transaction containing information for creating a smart contract (that is, deploying a contract) to the blockchain network shown in FIG. 1. A data field of the transaction includes code (such as bytecode or machine code) of the contract to be created, and a to field of the transaction is empty to indicate that the transaction is used for deploying the contract. After the nodes reach an agreement through a consensus mechanism, a contract address “0x6f8ae93 . . . ” of the contract is determined. Each node adds a contract account corresponding to the contract address of the smart contract to a state database, allocates state storage corresponding to the contract account, and saves the contract code to the state storage of the contract. As such, the contract is successfully created.

In a contract calling scenario, for example, Bob sends a transaction for calling a smart contract to the blockchain network shown in FIG. 1. A from field of the transaction is an address of an account of a transaction initiator (that is, Bob), and “0x6f8ae93 . . . ” in a to field represents an address of the called smart contract. A data field of the transaction includes methods and parameters for calling the smart contract. After consensus is reached on the transaction in the blockchain network, each node in the blockchain network can execute the transaction individually, thereby executing the contract individually and updating a state database based on the execution of the contract.

Blockchain nodes in the blockchain system can perform blockchain transactions. The blockchain nodes can include a plurality of threads so that the nodes can concurrently execute transactions through these threads. For example, when a plurality of transactions are to be executed, the blockchain node can distribute the plurality of transactions to a plurality of threads so that each of the threads can individually execute (that is, concurrently execute) the transactions received by each of the threads, thereby improving the overall execution efficiency of blockchain transactions.

In related technologies, blockchain nodes usually distribute the same quantity of transactions to each process based on the principle of load balancing, but the time needed to execute different blockchain transactions may be different. Therefore, the above-mentioned distribution method tends to limit transaction execution efficiency and resource utilization. For example, after thread A completes executing a transaction it has received, if thread B has not completed execution, the blockchain node needs to wait until thread B completes execution before submitting execution results of threads A and B together. During the above-mentioned waiting process, thread A cannot execute other transactions or events. It can be seen that the above-mentioned transaction distribution method results in large differences in the moments of completing the transactions by the threads. It not only leads to low overall execution efficiency of the blockchain transactions, but also affects the on-chain efficiency of the execution results and wastes computing resources of the threads that have completed the execution first.

To alleviate the above-mentioned problems in the related technologies and improve a transactions per second (TPS) indicator in the blockchain, the execution of the transaction can be accelerated. Specifically, blockchain nodes can execute transactions in parallel to accelerate the execution of the transactions. Generally, for transfer transactions, blockchain nodes first divide a plurality of transactions into a plurality of transaction groups based on accounts accessed by the transactions. Each transaction group does not access the same account so that the transaction groups can be executed in parallel. However, when a smart contract is called in a transaction, variables accessed in the transaction cannot be predicted before the transaction is executed. As a result, a plurality of transactions cannot be effectively grouped, and therefore, the transactions cannot be executed in parallel. In one or more embodiments, a first node (for example, node n1 in FIG. 1) in the blockchain can pre-execute a plurality of transactions to obtain a pre-executed read-write set of each transaction, and send the pre-executed read-write set to other nodes (for example, nodes n2 to n5 in FIG. 1) in the blockchain through a consensus process with other nodes. The pre-execution read-write set of the transaction includes, for example, a pre-execution read set and a pre-execution write set. The pre-execution read set includes key-value pairs of variables that are read in the pre-execution of the transaction. The pre-execution write set includes key-value pairs of variables that are written in the pre-execution of the transaction. The variables include, for example, externally owned accounts in the blockchain or variables defined in contract accounts. Other nodes in the blockchain network can group the plurality of transactions based on the pre-execution read-write sets of the plurality of transactions so that the plurality of transactions can be executed in parallel based on grouping results.

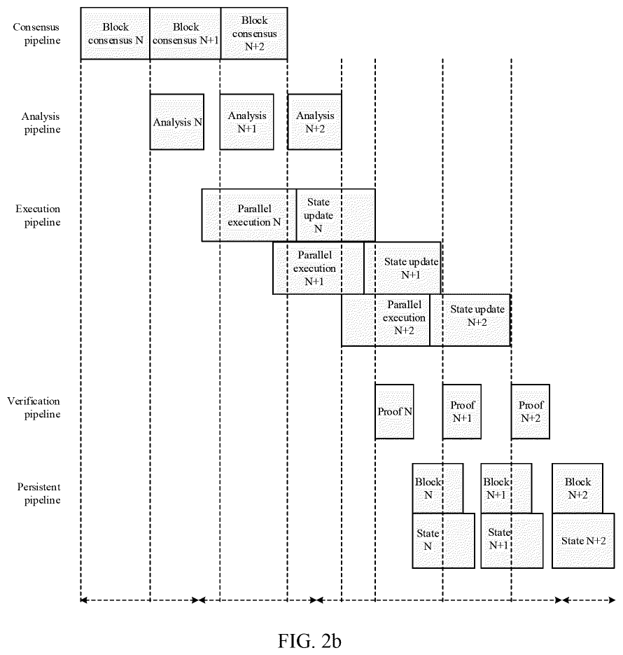

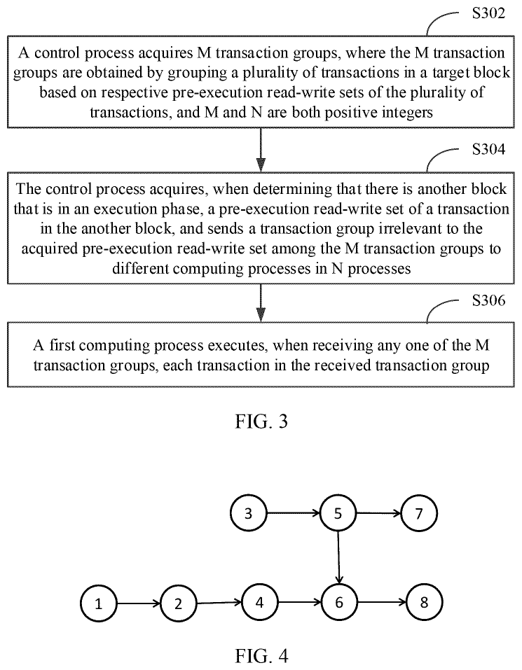

The plurality of transactions can be grouped using different algorithms, and the specific grouping method is to be described below. Therefore, details are omitted here in this specification. Certainly, a person skilled in the art can determine that the solutions above can optimize only a transaction execution way within a range of “each block in a blockchain node”, so as to improve the transaction execution efficiency of each above-mentioned block. For example, in a transaction execution flow shown in FIG. 2a, the blockchain node is processing transactions in block N, block N+1, and block N+2 in sequence in a pipelined way, and a parallel execution operation for each transaction is limited to within block N, block N+1, or block N+2. It can be seen that the blockchain nodes in the related technologies cannot optimize the execution efficiency of transactions in different blocks in dimensions above blocks (that is, cannot achieve a technical effect of improving the overall processing efficiency of the above-mentioned pipeline by implementing a case similar to the transaction execution flow shown in FIG. 2b, where the blockchain nodes execute transactions between block N and block N+1 or between block N+1 and block N+2 in parallel). Therefore, this application provides new transaction execution methods, and the transaction execution methods are to be described in detail with reference to FIG. 3.

FIG. 3 is a flowchart illustrating a transaction execution method, according to one or more example embodiments. As shown in FIG. 3, this method is applied to a first node in a blockchain system. The first node can be a node that initiates a consensus proposal (for example, a master node), or can be another blockchain node than the above-mentioned node (for example, a slave node). Regardless of the master node or slave node in the blockchain system, each node can be implemented as any apparatus, platform, device, or device cluster with computing/processing capabilities. The above-mentioned first node can include a control process and N computing processes. The method includes the following step S302 to step S306.

Step S302: The control process acquires M transaction groups, where the M transaction groups are obtained by grouping a plurality of transactions in a target block based on respective pre-execution read-write sets of the plurality of transactions, and M and N are positive integers.

As described above, the above-mentioned transaction groups can be obtained by grouping the plurality of transactions using different algorithms.

In one or more embodiments, the plurality of transactions can be grouped using a directed acyclic graph (DAG) algorithm. Specifically, first, a DAG graph between the plurality of transactions is drawn based on a dependency relationship between the transactions. For example, assume that the slave node executes the plurality of transactions based on an order that the master node pre-executes the plurality of transactions. Therefore, the dependency relationship between the transactions can be determined based on the pre-execution read-write sets and the pre-execution order of the plurality of transactions. If a pre-execution read set of one transaction and a pre-execution write set of another transaction include the same key, or a pre-execution write set of one transaction and a pre-execution write set of another transaction include the same key, the later pre-execution transaction (for example, transaction Tx2) of the two transactions needs to rely on the above-mentioned pre-execution transaction (for example, transaction Tx1). Therefore, in the DAG graph, transaction Tx1 can be drawn directed to transaction Tx2. In a case that transaction Tx2 relies on the execution of transaction Tx1, it can be considered that transaction Tx1 and transaction Tx2 are conflicting transactions and need to be executed in series, that is, transaction Tx2 is executed after transaction Tx1 is executed.

FIG. 4 is a schematic diagram illustrating a DAG graph of a plurality of transactions, according to one or more embodiments. Circles in the diagram represent nodes in the DAG graph, numerical digits in the circles represent transaction numbers, and arrows between the nodes represent directed connecting edges between the nodes. After the DAG graph of the plurality of transactions is obtained, the plurality of transactions can be grouped based on the DAG graph so that transactions in every two transaction groups are separated nodes in the DAG graph, that is, there is no connecting edge between any transaction in one transaction group and any transaction in another transaction group.

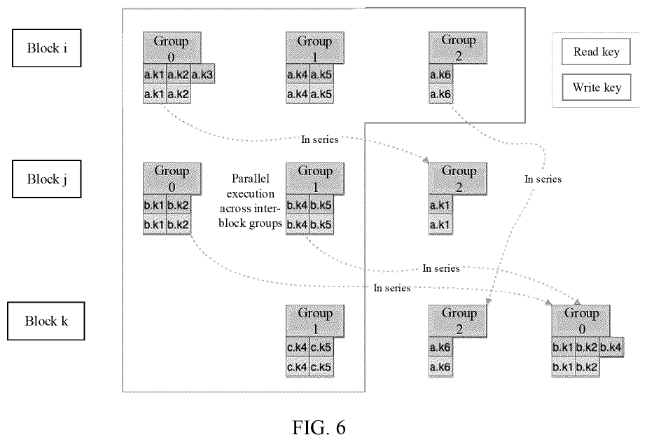

As shown in FIG. 6, a plurality of transactions (that is, transactions Tx1 to Tx8) connected by arrows are conflicting transactions and need to be divided into one transaction group. During execution of transactions Tx1 to Tx8, transactions (Tx3 and Tx5) and transactions (Tx1, Tx2, and Tx4) can be executed in parallel first, where transactions Tx3 and Tx5 are executed in series, and transactions Tx1, Tx2 and Tx4 need to be executed in series. Transaction Tx6 needs to wait until both transaction Tx4 and transaction Tx5 are executed, while transaction Tx7 and transaction Tx8 need to wait until both transaction Tx5 and transaction Tx6 are executed before they can be executed in parallel. Transaction Tx5 and transaction Tx6 connect at least three nodes, which can also be referred to as bifurcation points. In a case of a relatively large quantity of bifurcation points in the DAG graph, subsequent transactions may have a relatively long waiting time for the bifurcation points. In addition, the DAG algorithm needs more state space. Therefore, in a case of a relatively large quantity of conflicting transactions among a plurality of transactions, the efficiency of using the DAG grouping algorithm is reduced.

In another embodiment, the plurality of transactions can be grouped using a union-find set algorithm. A union-find set is a tree-like data structure used for handling merging and querying of disjoint sets. A union-find set usually includes two operations: find, which is used to query whether two elements are in the same set; and union, which is used to merge two disjoint sets into one set. Through this algorithm, when pre-execution read-write sets of two transactions include the same key, the two transactions can be merged into the same set. As such, a plurality of sets can be obtained, and transactions in every two sets do not access the same key, so that a plurality of sets can be processed in parallel. However, the union-find set algorithm does not consider whether access of the transactions to the key is read or write, and divides two transactions into one group as long as the two transactions access the same key. Therefore, two transactions that read the same key may be divided into the same group. Consequently, compared with the grouping results obtained using the DAG algorithm, the plurality of transaction groups obtained through grouping using the union-find set algorithm is low in parallelism.

In an actual business scene, a quantity of conflicting transactions among a plurality of transactions is uncertain, it may not be optimal to group transactions using the DAG algorithm or the union-find set algorithm alone. Therefore, a grouping algorithm can be adaptively determined based on a correlation degree of a plurality of transactions to group the transactions, thereby improving the efficiency of parallel execution of transactions. Specifically, the pre-execution read-write set of the above-mentioned transaction can involve a contract parameter. In the M transaction groups of the first node, transactions involving contract parameters of different contracts can be divided into different transaction groups. When an acquired pre-execution read-write set involves a contract parameter of a first contract, a transaction group irrelevant to the acquired pre-execution read-write set among the above-mentioned M transaction groups can include a transaction group that includes a transaction not involving the contract parameter of the first contract.

A world state maintained by the blockchain system corresponds to a state trie, and leaf nodes of the state trie include a contract account node and a plurality of contract parameter nodes. The contract account node is configured to record a contract account of a first contract deployed in the blockchain system, the plurality of contract parameter nodes are each configured to record state values of different contract parameters in the first contract, and update of the contract account node and update of the plurality of contract parameter nodes do not affect each other. The pre-execution read-write set of the transaction involves a contract parameter. In the M transaction groups, transactions involving different contracts or involving different contract parameters of a same contract are divided into different transaction groups. When the acquired pre-execution read-write set involves any contract parameter of the first contract, the transaction group irrelevant to the acquired pre-execution read-write set among the M transaction groups includes a transaction group that includes a transaction not involving the first contract or involving the first contract but not involving the any contract parameter.

As described above, accounts in the above-mentioned blockchain system are usually divided into two types: user accounts/externally owned accounts and contract accounts. The contract account is configured to store contract code of a smart contract and values of related states, and can usually only be activated and called by an externally owned account. The design of externally owned accounts and contract accounts is actually a mapping of account address to account states. Account states can usually include but are not limited to fields such as Nonce, Balance, Storage_Root, CodeHash, etc., where Nonce and Balance exist in both externally owned accounts and contract accounts, while CodeHash and Storage_Root attributes are usually valid only in contract accounts. In the above-mentioned fields, Nonce represents a counter, and its value, for an externally owned account, represents a quantity of transactions sent from an address of the account, while for a contract account, it represents a quantity of smart contracts created by the account. A value of Balance represents an amount of digital resources owned by a corresponding externally owned account. Storage_Root represents a hash of a root node of a Merkle Patricia tree (MPT). The MPT is used to organize the storage of state variables of a contract account. CodeHash represents a hash value of the contract code, and for a contract account, it is the code that a smart contract is hashed and stored, while for an externally owned account, it can be an empty string or an all-O string because the smart contract is not included.

The MPT is a tree structure that combines a Merkle tree and a Patricia tree (compact prefix tree, a more space-saving trie tree). Regarding the Merkle tree, a Merkle tree algorithm calculates a hash value for each transaction, and then connects every two transactions and calculates a hash, until the top Merkle root. An improved MPT tree is used in Ethereum, for example, a structure of a 16-branch tree, also commonly referred to as an MPT tree for short. The data structure of the Ethernet MPT tree includes a state trie. The state trie includes a key-value pair of the storage content corresponding to each account in Ethereum. The “key” in the state trie can be an identifier with a length of 160 bits (such as an address of an Ethereum account). This account address is distributed in the storage from a root node to a leaf node of the state trie. The “value” in the state trie is generated by encoding information about the Ethereum account (using a recursive-length prefix encoding (RLP) method). As described above, for externally owned accounts, the values can include Nonce and Balance, while for contract accounts, the values can include Nonce, Balance, CodeHash, and Storage_Root.

In one or more embodiments, a world state maintained by the blockchain system corresponds to a state trie, and leaf nodes of the state trie include a contract account node and a plurality of contract parameter nodes. The contract account node is configured to record a contract account of a first contract deployed in the blockchain system, the plurality of contract parameter nodes are each configured to record state values of different contract parameters in the first contract, and update of the contract account node and update of the plurality of contract parameter nodes do not affect each other. The pre-execution read-write set of the transaction involves a contract parameter. In the M transaction groups, transactions involving different contracts or involving different contract parameters of a same contract are divided into different transaction groups. In addition, when the acquired pre-execution read-write set involves any contract parameter of the first contract, the transaction group irrelevant to the acquired pre-execution read-write set among the M transaction groups includes a transaction group that includes a transaction not involving the first contract or involving the first contract but not involving the any contract parameter. Certainly, the above-mentioned first node further includes a storage process so that the first computing process can send a state value of the any contract parameter to the storage process, and the storage process updates, based on the state value of the any contract parameter, a state value recorded by a contract parameter node corresponding to the any contract parameter in the state trie.

In this solution, a world state maintained by the blockchain system corresponds to a state trie, and leaf nodes of the state trie include a contract account node and a plurality of contract parameter nodes. The contract account node is configured to record a contract account of a first contract deployed in the blockchain system. The plurality of contract parameter nodes are each configured to record state values of different contract parameters in the first contract. In addition, as described above, for the contract account node and the contract parameter nodes in the state trie in this solution, update of any two nodes does not affect each other. Therefore, update of the contract account node corresponding to the first node and update of the plurality of contract parameter nodes corresponding to the first node also do not affect each other.

In one or more embodiments, a state value of the any contract parameter can be recorded in a corresponding contract parameter node as a key-value pair, where a key of the any contract parameter can be calculated based on contract information of the first contract and parameter information of the any contract parameter. For example, the contract information of the first contract can include a contract address or a hash of the contract address, etc. The parameter information of the any contract parameter can include a parameter name, a parameter number, a hash thereof, etc. As shown in FIG. 2a and FIG. 2b, for example, the contract information is a contract address and the parameter information is a parameter name. For parameter A, an account address (for example, “0x00001234 . . . 123”) of account 2 and a parameter name (for example, “average order quantity”) of parameter A can be spliced into a parameter identifier (for example, “0x00001234 . . . 123_average order quantity”) based on a predetermined rule, and then a hash value of the parameter identifier is calculated as a key value of parameter A. Certainly, the key can be determined using other methods. Implementations are not limited in this specification. As such, contract parameter nodes corresponding to contract parameters in the same smart contract can be distributed more centrally in the state trie, thereby facilitating subsequent parameter search and state value update.

A person skilled in the art can understand that in the related technologies, Storage_Root of a single contract account in the state trie is directed to another storage trie that is also in a form of an MPT. The storage trie is configured to store data of state variables involved in contract execution. A value of Storage_Root is usually a hash value of a root node of the storage trie. However, all the contract parameters of the same smart contract are recorded in the storage trie corresponding to the contract. Therefore, after a blockchain transaction is executed to generate state data (including contract state data and world state data) for different contract parameters, it is necessary to first submit the contract state data to obtain Storage_Root of the contract account, then update Storage_Root of a related contract account in the state trie, and then submit the world state data to obtain State_Root of the state trie. Clearly, as such, the state values of different contract parameters in the same smart contract need to be updated sequentially, but cannot be updated in parallel, which limits the update efficiency and block-out speed of the state trie. Therefore, the contract account node may not record the value of the Storage_Root field so as to remove the above-mentioned restrictions to a certain extent and improve the update efficiency and block-out speed of the state trie.

The above-mentioned transaction group can be acquired by the control process based on group information of the first node, and can also be acquired by the control process based on group information from a second node in the blockchain system. Implementations are not limited in this specification.

In one or more embodiments, the control process pre-executes the plurality of transactions and divides the plurality of transactions into the M transaction groups based on an obtained pre-execution read-write set. In another embodiment, the first node further includes a first consensus process; and the control process can divide the plurality of transactions into the M transaction groups based on the respective pre-execution read-write sets of the plurality of transactions received by the first consensus process from a second node in the blockchain system. Based on this, the control process can acquire, from the first consensus process, the M transaction groups obtained through grouping by the control process. For a specific implementation of the above-mentioned acquisition, references can be made to the description in the above-mentioned embodiment, and details are omitted here.

In the above-mentioned embodiment, the control process can determine a read-write set conflict relationship among the plurality of transactions based on the respective pre-executed read-write sets of the plurality of transactions, determine a pre-and-post dependency relationship of at least some of the plurality of transactions based on the read-write set conflict relationship, and group the plurality of transactions based on the pre-and-post dependency relationship to obtain the M transaction groups.

Step S304: The control process acquires, when determining that there is another block that is in an execution phase, a pre-execution read-write set of a transaction in the another block, and sends a transaction group irrelevant to the acquired pre-execution read-write set among the M transaction groups to different computing processes in the N processes.

When the control process determines that there is another block that is in the execution phase, the control process can acquire a pre-execution read-write set of a transaction in the another block, determines, by comparing a difference between the acquired pre-execution read-write set and the pre-execution read-write set of the target block, transaction groups irrelevant to each other in the target block and the another block, and then sends the irrelevant transaction groups to the computing processes together to implement parallel processing of some transaction groups in the target block and the another block, thereby improving the overall processing efficiency of the transaction groups in both the target block and the another block. This case is to be illustrated below with reference to FIG. 6. As shown in FIG. 6, assume that the first node includes contracts a {k1, k2, k3, k4, k5, k6}, contract b {k1, k2, k4, k5}, and contract c {k4, k5} (contract parameters corresponding to each contract are included within brackets). Using transaction groups 0, 1, and 2 in block i and transaction groups 0, 1, and 2 in block j as an example, because pre-execution read sets of transactions in transaction groups 0 and 1 of block j do not involve a pre-execution write set of a transaction in any transaction group in block i, but a pre-execution read set of a transaction in transaction group 2 in block j is a.k1 (that is, the contract parameter k1 of contract a), it can be considered that the two transaction groups (that is, transaction groups 0 and 1) in block j are irrelevant to a pre-execution read-write set of block i. At this time, transaction groups 0, 1, and 2 in block i and transaction groups 0 and 1 in block j can be sent to different computing processes in the N processes to implement parallel processing of the respective transaction groups in the two blocks.

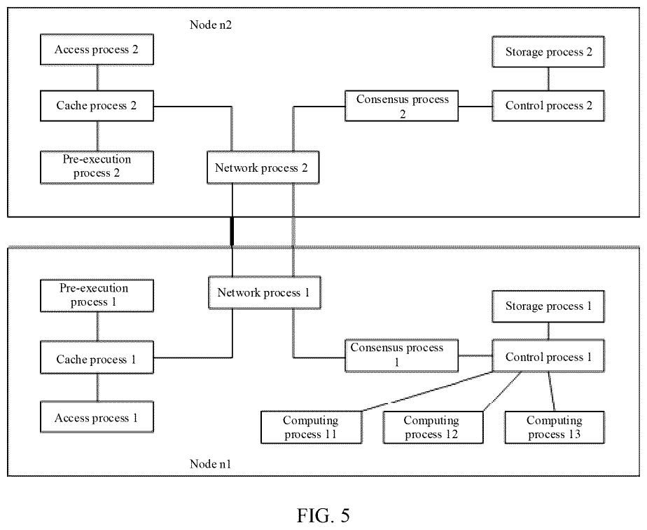

Certainly, in the process of sending the above-mentioned transaction groups, a processing method based on a cache process similar to the caching mechanism in FIG. 5 can be used. To be specific, a parallel processing threshold or a parallel processing period is predetermined, so that the above-mentioned irrelevant transaction groups can be sent only when it is determined that a quantity of transaction groups that can be processed in parallel is greater than the above-mentioned parallel processing threshold, or that a time from the earliest determined transaction groups that can be processed in parallel exceeds the above-mentioned parallel processing period, so as to reduce the waste of resources caused by frequent sending of transaction groups. Alternatively, a quantity of transactions for each consensus can be set as early as a consensus phase of transaction groups, so as to increase a quantity of transactions in each transaction group, thereby achieving a technical effect similar to the above-mentioned parallel processing threshold or parallel processing period.

For example, when MEN, the control process can send the M transaction groups to M computing processes, where any one of the computing processes receives a transaction group. When M>N, the control process can send the M transaction groups equally to N computing processes, where a difference between quantities of transaction groups received by any two of the computing processes is not greater than 1. Through the above-mentioned method, quantities of transaction groups received by the computing processes that receives the transaction groups can be as close as possible, thereby improving the overall execution efficiency of the M transaction groups. Alternatively, N control processes can compete with each other to acquire the M transaction groups, and any of the computing processes can continue to compete to acquire a next transaction group after executing each transaction in any of the transaction groups, until all the M transaction groups are distributed. Through this method, a quantity of transaction groups acquired by each control process is related to a transaction execution capability of the control process, thereby achieving load balancing of a plurality of computing processes to some extent.

Step S306: A first computing process executes, when receiving any one of the M transaction groups, each transaction in the received transaction group.

After receiving the transaction group sent by the above-mentioned control process, the above-mentioned first computing process can perform a corresponding execution operation on the transactions in the transaction group. The above-mentioned first computing process can concurrently execute transactions in a plurality of received transaction groups through a plurality of threads, thereby further improving the execution efficiency of the transactions.

In one or more embodiments, the blockchain system further includes a second node, where the second node includes a pre-execution process and a cache process, and state data are stored in a memory of the cache process. The cache process is configured to send the plurality of transactions to the pre-execution process, where the plurality of transactions are received by the first node and stored in the memory of the cache process. The pre-execution process is configured to pre-execute the plurality of transactions and generate pre-execution read-write sets of the plurality of transactions, and is specifically configured to receive a state value of a parameter of the first contract from the cache process when the state value of the parameter of the first contract is stored in the memory of the cache process and when the state value is to be read during pre-execution of any transaction in the plurality of transactions, and generate a pre-execution read-write set of the any transaction based on the state value. In one or more embodiments, the cache process is further configured to store the pre-execution read-write sets of the plurality of transactions and a pre-execution order of the plurality of transactions in the memory of the cache process, and update the state data stored in the memory based on the pre-execution read-write sets of the plurality of transactions.

In one or more embodiments, the second node further includes a second consensus process, and the cache process is further configured to send the pre-execution read-write sets and the pre-execution order of the plurality of transactions to the second consensus process. The second consensus process is configured to generate a consensus proposal, and send the consensus proposal to a first consensus process in the first node, where the consensus proposal includes the pre-execution read-write sets and a consensus order of the plurality of transactions, and the consensus order is the pre-execution order.

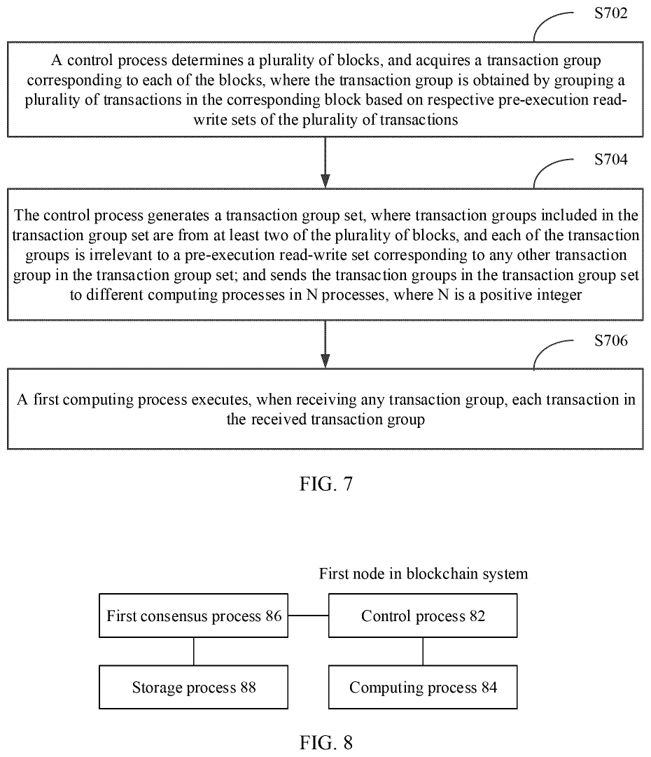

FIG. 7 is a flowchart illustrating a transaction execution method, according to one or more example embodiments. As shown in FIG. 7, this method is applied to a first node in a blockchain system. The first node can be a node that initiates a consensus proposal (for example, a master node), or can be another blockchain node than the above-mentioned node (for example, a slave node). The above-mentioned first node can include a control process and N computing processes. The method includes the following steps.

S702: The control process determines a plurality of blocks, and acquires a transaction group corresponding to each of the blocks, where the transaction group is obtained by grouping a plurality of transactions in the corresponding block based on respective pre-execution read-write sets of the plurality of transactions.

As described above, the pre-execution read-write set of the transaction involves a contract parameter. In the transaction group of each of the blocks, transactions involving contract parameters of different contracts are divided into different transaction groups. When a pre-execution read-write set acquired by any of the blocks involves a contract parameter of a first contract, a transaction group in a transaction group set below includes a transaction group that corresponds to a block other than the any block and that includes a transaction not involving the contract parameter of the first contract.

As described above, a world state maintained by the blockchain system corresponds to a state trie, and leaf nodes of the state trie include a contract account node and a plurality of contract parameter nodes. The contract account node is configured to record a contract account of a first contract deployed in the blockchain system, the plurality of contract parameter nodes are each configured to record state values of different contract parameters in the first contract, and update of the contract account node and update of the plurality of contract parameter nodes do not affect each other. The pre-execution read-write set of the transaction involves a contract parameter. In transaction groups of any block, transactions involving different contracts or involving different contract parameters of a same contract are divided into different transaction groups. When an acquired pre-execution read-write set involves any contract parameter of the first contract, the transaction groups in the transaction group set include a transaction group that corresponds to a block other than the any block and that includes a transaction not involving the first contract or involving the first contract but not involving the any contract parameter of the first contract.

As described above, the first computing process is configured to send a state value of the any contract parameter to the storage process. The storage process is configured to update, based on the state value of the any contract parameter, a state value recorded by a contract parameter node corresponding to the any contract parameter in the state trie.

As described above, a state value of the any contract parameter is recorded in a corresponding contract parameter node as a key-value pair, where a key of the any contract parameter is calculated based on contract information of the first contract and parameter information of the any contract parameter.

As described above, the contract account node does not record a value of a Storage_Root field.

S704: The control process generates a transaction group set, where transaction groups included in the transaction group set are from at least two of the plurality of blocks, and each of the transaction groups is irrelevant to a pre-execution read-write set corresponding to any other transaction group in the transaction group set; and sends the transaction groups in the transaction group set to different computing processes in the N processes, where N is a positive integer.

As described above, the control process acquires the above-mentioned transaction group set based on group information from a second node in the blockchain system.

As described above, the acquiring, by the control process, the transaction group set includes: the control process pre-executes the plurality of transactions, and divides the plurality of transactions into the above-mentioned transaction group set based on an obtained pre-executed read-write set. Alternatively, the first node further includes a first consensus process, and the generating, by the control process, a transaction group set includes: the control process divides the plurality of transactions into the above-mentioned transaction group set based on the respective pre-execution read-write sets of the plurality of transactions received by the first consensus process from a second node in the blockchain system.

As described above, the dividing the plurality of transactions into the above-mentioned transaction group set includes: The control process determines a read-write set conflict relationship among the plurality of transactions based on the respective pre-executed read-write sets of the plurality of transactions, determines a pre-and-post dependency relationship of at least some of the plurality of transactions based on the read-write set conflict relationship, and groups the plurality of transactions based on the pre-and-post dependency relationship to obtain the above-mentioned transaction group set.

S706: A first computing process executes, when receiving any transaction group, each transaction in the received transaction group.

As described above, the first computing process concurrently executes transactions in a plurality of received transaction groups through a plurality of threads.

FIG. 8 is a schematic structural diagram illustrating a first node in a blockchain system, according to one or more example embodiments. As shown in FIG. 8, the first node includes a control process 82 and N computing processes 84. The control process 82 is configured to acquire M transaction groups, where the M transaction groups are obtained by grouping a plurality of transactions in a target block based on respective pre-execution read-write sets of the plurality of transactions, and M and N are positive integers. The control process 82 is further configured to acquire, when determining that there is another block that is in an execution phase, a pre-execution read-write set of a transaction in the another block, and send a transaction group irrelevant to the acquired pre-execution read-write set among the M transaction groups to different computing processes in the N processes. A first computing process in the computing processes 84 is configured to execute, when receiving any one of the M transaction groups, each transaction in the received transaction group.

Optionally, the pre-execution read-write set of the transaction involves a contract parameter. In the M transaction groups, transactions involving contract parameters of different contracts are divided into different transaction groups; and when the acquired pre-execution read-write set involves a contract parameter of a first contract, the transaction group irrelevant to the acquired pre-execution read-write set among the M transaction groups includes a transaction group that includes a transaction not involving the contract parameter of the first contract.

Optionally, a world state maintained by the blockchain system corresponds to a state trie, and leaf nodes of the state trie include a contract account node and a plurality of contract parameter nodes. The contract account node is configured to record a contract account of a first contract deployed in the blockchain system, the plurality of contract parameter nodes are each configured to record state values of different contract parameters in the first contract, and update of the contract account node and update of the plurality of contract parameter nodes do not affect each other. The pre-execution read-write set of the transaction involves a contract parameter. In the M transaction groups, transactions involving different contracts or involving different contract parameters of a same contract are divided into different transaction groups. When the acquired pre-execution read-write set involves any contract parameter of the first contract, the transaction group irrelevant to the acquired pre-execution read-write set among the M transaction groups includes a transaction group that includes a transaction not involving the first contract or involving the first contract but not involving the any contract parameter.

Optionally, the first node further includes a storage process 88. The first computing process is further configured to send a state value of the any contract parameter to the storage process 88. The storage process 88 is configured to update, based on the state value of the any contract parameter, a state value recorded by a contract parameter node corresponding to the any contract parameter in the state trie.

Optionally, a state value of the any contract parameter is recorded in a corresponding contract parameter node as a key-value pair, where a key of the any contract parameter is calculated based on contract information of the first contract and parameter information of the any contract parameter.

Optionally, the contract account node does not record a value of a Storage_Root field.

Optionally, the control process 82 is further configured to acquire the M transaction groups based on group information from a second node in the blockchain system.

Optionally, the control process 82 is further configured to pre-execute the plurality of transactions, and divide the plurality of transactions into the M transaction groups based on an obtained pre-execution read-write set. Alternatively, the first node further includes a first consensus process 86; and the control process 82 is further configured to divide the plurality of transactions into the M transaction groups based on the respective pre-execution read-write sets of the plurality of transactions received by the first consensus process 86 from a second node in the blockchain system.

Optionally, the control process 82 is further configured to determine a read-write set conflict relationship among the plurality of transactions based on the respective pre-executed read-write sets of the plurality of transactions, determine a pre-and-post dependency relationship of at least some of the plurality of transactions based on the read-write set conflict relationship, and group the plurality of transactions based on the pre-and-post dependency relationship to obtain the M transaction groups.

Optionally, the first computing process is further configured to concurrently execute transactions in a plurality of received transaction groups through a plurality of threads.

For a specific implementation of a transaction distribution process of the first node, references can be made to the description in the above-mentioned embodiment, and details are omitted here.

Based on the same idea as the above-mentioned method embodiment, the embodiments of this specification further provide a blockchain system. The blockchain system includes a first node, where the first node includes a control process and N computing processes. The control process is configured to acquire M transaction groups, where the M transaction groups are obtained by grouping a plurality of transactions in a target block based on respective pre-execution read-write sets of the plurality of transactions, and M and N are positive integers. The control process is configured to acquire, when determining that there is another block that is in an execution phase, a pre-execution read-write set of a transaction in the another block, and send a transaction group irrelevant to the acquired pre-execution read-write set among the M transaction groups to different computing processes in the N processes. A first computing process is configured to execute, when receiving any one of the M transaction groups, each transaction in the received transaction group.

Optionally, the pre-execution read-write set of the transaction involves a contract parameter. In the M transaction groups, transactions involving contract parameters of different contracts are divided into different transaction groups; and when the acquired pre-execution read-write set involves a contract parameter of a first contract, the transaction group irrelevant to the acquired pre-execution read-write set among the M transaction groups includes a transaction group that includes a transaction not involving the contract parameter of the first contract.

Optionally, a world state maintained by the blockchain system corresponds to a state trie, and leaf nodes of the state trie include a contract account node and a plurality of contract parameter nodes. The contract account node is configured to record a contract account of a first contract deployed in the blockchain system, the plurality of contract parameter nodes are each configured to record state values of different contract parameters in the first contract, and update of the contract account node and update of the plurality of contract parameter nodes do not affect each other. The pre-execution read-write set of the transaction involves a contract parameter. In the M transaction groups, transactions involving different contracts or involving different contract parameters of a same contract are divided into different transaction groups. When the acquired pre-execution read-write set involves any contract parameter of the first contract, the transaction group irrelevant to the acquired pre-execution read-write set among the M transaction groups includes a transaction group that includes a transaction not involving the first contract or involving the first contract but not involving the any contract parameter.

Optionally, the first computing process is configured to send a state value of the any contract parameter to the storage process. The storage process is configured to update, based on the state value of the any contract parameter, a state value recorded by a contract parameter node corresponding to the any contract parameter in the state trie.

Optionally, a state value of the any contract parameter is recorded in a corresponding contract parameter node as a key-value pair, where a key of the any contract parameter is calculated based on contract information of the first contract and parameter information of the any contract parameter.

Optionally, the contract account node does not record a value of a Storage_Root field.

Optionally, the control process is configured to acquire the M transaction groups based on group information from a second node in the blockchain system.

Optionally, the control process is further configured to pre-execute the plurality of transactions, and divide the plurality of transactions into the M transaction groups based on an obtained pre-execution read-write set. Alternatively, the first node further includes a first consensus process; and the control process is further configured to divide the plurality of transactions into the M transaction groups based on the respective pre-execution read-write sets of the plurality of transactions received by the first consensus process from a second node in the blockchain system.

Optionally, the control process is further configured to determine a read-write set conflict relationship among the plurality of transactions based on the respective pre-executed read-write sets of the plurality of transactions, determine a pre-and-post dependency relationship of at least some of the plurality of transactions based on the read-write set conflict relationship, and group the plurality of transactions based on the pre-and-post dependency relationship to obtain the M transaction groups.

Optionally, the first computing process is further configured to concurrently execute transactions in a plurality of received transaction groups through a plurality of threads.

Still using FIG. 8 as an example, the first node includes a control process 82 and N computing processes 84. The control process 82 is configured to determine a plurality of blocks, and acquire a transaction group corresponding to each of the blocks, where the transaction group is obtained by grouping a plurality of transactions in the corresponding block based on respective pre-execution read-write sets of the plurality of transactions. The control process 82 is configured to generate a transaction group set, where transaction groups included in the transaction group set are from at least two of the plurality of blocks, and each of the transaction groups is irrelevant to a pre-execution read-write set corresponding to any other transaction group in the transaction group set; and send the transaction groups in the transaction group set to different computing processes in the N processes, where N is a positive integer. A first computing process in the computing processes 84 is configured to execute, when receiving any transaction group, each transaction in the received transaction group.

Optionally, the pre-execution read-write set of the transaction involves a contract parameter. In the transaction group of each of the blocks, transactions involving contract parameters of different contracts are divided into different transaction groups. When a pre-execution read-write set acquired by any of the blocks involves a contract parameter of a first contract, a transaction group in a transaction group set below includes a transaction group that corresponds to a block other than the any block and that includes a transaction not involving the contract parameter of the first contract.

Optionally, a world state maintained by the blockchain system corresponds to a state trie, and leaf nodes of the state trie include a contract account node and a plurality of contract parameter nodes. The contract account node is configured to record a contract account of a first contract deployed in the blockchain system, the plurality of contract parameter nodes are each configured to record state values of different contract parameters in the first contract, and update of the contract account node and update of the plurality of contract parameter nodes do not affect each other. The pre-execution read-write set of the transaction involves a contract parameter. In transaction groups of any block, transactions involving different contracts or involving different contract parameters of a same contract are divided into different transaction groups. When an acquired pre-execution read-write set involves any contract parameter of the first contract, the transaction groups in the transaction group set include a transaction group that corresponds to a block other than the any block and that includes a transaction not involving the first contract or involving the first contract but not involving the any contract parameter of the first contract.

Optionally, the first computing process is configured to send a state value of the any contract parameter to the storage process. The storage process is configured to update, based on the state value of the any contract parameter, a state value recorded by a contract parameter node corresponding to the any contract parameter in the state trie.

Optionally, a state value of the any contract parameter is recorded in a corresponding contract parameter node as a key-value pair, where a key of the any contract parameter is calculated based on contract information of the first contract and parameter information of the any contract parameter.

Optionally, the contract account node does not record a value of a Storage_Root field.

Optionally, the control process is configured to acquire the above-mentioned transaction group set based on group information from a second node in the blockchain system.

Optionally, the control process is configured to acquire the transaction group set, including: the control process pre-executes the plurality of transactions, and divides the plurality of transactions into the above-mentioned transaction group set based on an obtained pre-executed read-write set. Alternatively, the first node further includes a first consensus process, and the control process is configured to generate a transaction group set, including: the control process divides the plurality of transactions into the above-mentioned transaction group set based on the respective pre-execution read-write sets of the plurality of transactions received by the first consensus process from a second node in the blockchain system.

Optionally, the dividing the plurality of transactions into the above-mentioned transaction group set includes: The control process determines a read-write set conflict relationship among the plurality of transactions based on the respective pre-executed read-write sets of the plurality of transactions, determines a pre-and-post dependency relationship of at least some of the plurality of transactions based on the read-write set conflict relationship, and groups the plurality of transactions based on the pre-and-post dependency relationship to obtain the afore-mentioned transaction group set.

Optionally, the first computing process is configured to concurrently execute transactions in a plurality of received transaction groups through a plurality of threads.

For a specific implementation of a transaction distribution process of the first node, references can be made to the description in the above-mentioned embodiment, and details are omitted here.

Based on the same idea as the above-mentioned method embodiment, the embodiments of this specification further provide another blockchain system. The blockchain system includes a first node, where the first node includes a control process and N computing processes. The control process is configured to determine a plurality of blocks, and acquire a transaction group corresponding to each of the blocks, where the transaction group is obtained by grouping a plurality of transactions in the corresponding block based on respective pre-execution read-write sets of the plurality of transactions. The control process is configured to generate a transaction group set, where transaction groups included in the transaction group set are from at least two of the plurality of blocks, and each of the transaction groups is irrelevant to a pre-execution read-write set corresponding to any other transaction group in the transaction group set; and send the transaction groups in the transaction group set to different computing processes in the N processes, where N is a positive integer. A first computing process is configured to execute, when receiving any transaction group, each transaction in the received transaction group.

Optionally, the pre-execution read-write set of the transaction involves a contract parameter. In the transaction group of each of the blocks, transactions involving contract parameters of different contracts are divided into different transaction groups. When a pre-execution read-write set acquired by any of the blocks involves a contract parameter of a first contract, a transaction group in a transaction group set below includes a transaction group that corresponds to a block other than the any block and that includes a transaction not involving the contract parameter of the first contract.

Optionally, a world state maintained by the blockchain system corresponds to a state trie, and leaf nodes of the state trie include a contract account node and a plurality of contract parameter nodes. The contract account node is configured to record a contract account of a first contract deployed in the blockchain system, the plurality of contract parameter nodes are each configured to record state values of different contract parameters in the first contract, and update of the contract account node and update of the plurality of contract parameter nodes do not affect each other. The pre-execution read-write set of the transaction involves a contract parameter. In transaction groups of any block, transactions involving different contracts or involving different contract parameters of a same contract are divided into different transaction groups. When an acquired pre-execution read-write set involves any contract parameter of the first contract, the transaction groups in the transaction group set include a transaction group that corresponds to a block other than the any block and that includes a transaction not involving the first contract or involving the first contract but not involving the any contract parameter of the first contract.

Optionally, the first computing process is configured to send a state value of the any contract parameter to the storage process. The storage process is configured to update, based on the state value of the any contract parameter, a state value recorded by a contract parameter node corresponding to the any contract parameter in the state trie.

Optionally, a state value of the any contract parameter is recorded in a corresponding contract parameter node as a key-value pair, where a key of the any contract parameter is calculated based on contract information of the first contract and parameter information of the any contract parameter.

Optionally, the contract account node does not record a value of a Storage_Root field.

Optionally, the control process is configured to acquire the above-mentioned transaction group set based on group information from a second node in the blockchain system.

Optionally, the control process is configured to acquire the transaction group set, including: the control process pre-executes the plurality of transactions, and divides the plurality of transactions into the above-mentioned transaction group set based on an obtained pre-executed read-write set. Alternatively, the first node further includes a first consensus process, and the control process is configured to generate a transaction group set, including: the control process divides the plurality of transactions into the above-mentioned transaction group set based on the respective pre-execution read-write sets of the plurality of transactions received by the first consensus process from a second node in the blockchain system.

Optionally, the dividing the plurality of transactions into the above-mentioned transaction group set includes: The control process determines a read-write set conflict relationship among the plurality of transactions based on the respective pre-executed read-write sets of the plurality of transactions, determines a pre-and-post dependency relationship of at least some of the plurality of transactions based on the read-write set conflict relationship, and groups the plurality of transactions based on the pre-and-post dependency relationship to obtain the above-mentioned transaction group set.

Optionally, the first computing process is configured to concurrently execute transactions in a plurality of received transaction groups through a plurality of threads.

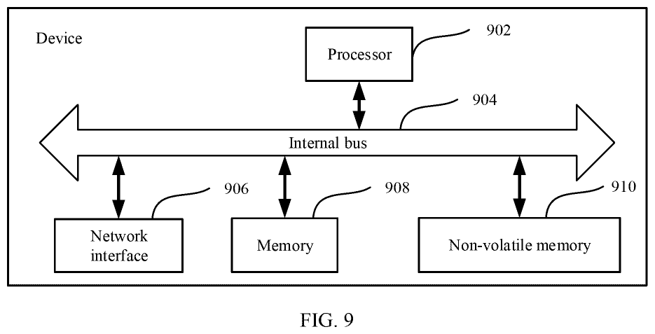

FIG. 9 is a schematic structural diagram of a device, according to one or more example embodiments. Referring to FIG. 9, at a hardware level, the device includes a processor 902, an internal bus 904, a network interface 906, a memory 908, and a nonvolatile storage device 910, and certainly may further include other hardware needed by a service. One or more embodiments of this specification can be implemented based on software. For example, the processor 902 reads a corresponding computer program from the nonvolatile storage device 910 to the memory 908 and then runs the computer program. Certainly, in addition to software implementations, one or more embodiments of this specification do not preclude other implementations, such as a logic device or a combination of software and hardware. In other words, an execution body of the following processing procedure is not limited to each logical unit, and can be hardware or a logic device.

In the 1990s, it was clear whether an improvement of a technology was a hardware improvement (for example, an improvement of the circuit structure such as diodes, transistors, and switches) or a software improvement (an improvement of the method flow). However, with the development of technology, the improvement of many methods can be regarded as a direct improvement of the hardware circuit structure. Almost all designers get the corresponding hardware circuit structure by programming the improved method flow into the hardware circuit. Therefore, a method procedure can be improved by using a hardware entity module. For example, a Programmable Logic Device (PLD), such as a Field Programmable Gate Array (FPGA), is such an integrated circuit whose logic functions are determined by the user programming the device. By the designer's own programming to “integrate” a digital system on a PLD, without asking the chip manufacturer to design and produce a special integrated circuit chip. Moreover, now, instead of manually making an integrated circuit chip, this programming is mostly executed with “logic compiler” software, which is similar to a software compiler used when the program is developed, and the original code before it is compiled also has to be written in a specific programming language, which is referred to as Hardware Description Language (HDL), and there is not just one HDL, but many HDLs, such as Advanced Boolean Expression Language (ABEL), Altera Hardware Description Language (AHDL), Confluence, Cornell University Programming Language (CUPL), HDCal, Java Hardware Description Language (JHDL), Lava, Lola, MyHDL, PALASM, and Ruby Hardware Description Language (RHDL). Very-High-Speed Integrated Circuit Hardware Description Language (VHDL) and Verilog are the most commonly used currently. Persons skilled in the art should also know that only by using the above-mentioned hardware description languages to perform a little logic programming on the method flow and programming same into the integrated circuit, the hardware circuit for realizing the logic method flow can be easily obtained.

The controller can be implemented in any appropriate way, for example, the controller can be in the form of, for example, a microprocessor or processor and a computer readable medium, logic gates, switches, an Application Specific Integrated Circuit (ASIC), programmable logic controllers, and embedded microcontrollers, which store the computer readable program code (for example, software or firmware) that can be executed by the (micro) processor. Examples of the controller include, but are not limited to, the following microcontrollers: ARC 625D, Atmel AT91SAM, Microchip PIC18F26K20, and Silicone Labs C8051F320. The storage device controllers can also be implemented as part of the storage device control logic. A person skilled in the art also knows that in addition to implementing the controller by using only the computer-readable program code, logic programming can be performed on method steps to enable the controller to implement the same function in forms of the logic gate, the switch, the application-specific integrated circuit, the programmable logic controller, the built-in microcontroller, etc. Therefore, the controller can be considered as a hardware component, and an apparatus included in the controller for implementing various functions can also be considered as a structure in the hardware component. Or the apparatus for implementing various functions can even be considered as both a software module for implementing a method and the structure in the hardware component.

The system, apparatus, module, or unit stated in the above-mentioned embodiments can specifically be implemented using a computer chip or entity, or can be implemented by a product having a certain function. A typical implementing device is a server system. Certainly, this application does not exclude that with development of future computer technologies, a computer that implements a function of the above-mentioned embodiment can be, for example, a personal computer, a laptop computer, a vehicle-mounted man-machine interaction device, a cellular phone, a camera phone, a smartphone, a personal digital assistant, a media player, a navigation device, an e-mail device, a game console, a tablet computer, a wearable device, or a combination of any of these devices.

Although one or more embodiments of this specification provide method operating steps as described in one or more embodiments or a flowchart, more or fewer operating steps can be included on the basis of conventional or noncreative means. The sequence of steps enumerated in the embodiments is only one way among multiple step execution sequences and does not represent a unique sequence of execution. When executed in an actual apparatus or end product, it can be executed sequentially or in parallel in accordance with the method sequence shown in the embodiments or the accompanying drawings (for example, a parallel processor or multithreaded processing environment, or even a distributed data processing environment). The term “include”, “comprise”, or any other variation thereof is intended to cover non-exclusive inclusion, such that a process, method, product, or device including a set of elements includes not only those elements but also other elements not explicitly listed, or elements inherent to such a process, method, product, or device. Without further limitations, it does not preclude the existence of additional identical or equivalent elements in the process, method, product or device including such elements. For example, if the words first, second, etc. are used for indicating names, they do not indicate any particular order.

For the convenience of description, the above-mentioned apparatuses are divided into various modules based on functions for respective descriptions. Certainly, when implementing one or more of this specification, functions of various modules can be realized in the same or more software and/or hardware, and the modules that achieve the same function can also be realized by a combination of multiple sub-modules or sub-units. The apparatus embodiments described above are only schematic, for example, the division of units is only a logical function division; in actual implementation, there can be other ways of division; for example, multiple units or assemblies can be combined or can be integrated into another system, or some features can be omitted, or not performed. On the other hand, the coupling or direct coupling or communicative connection between each other shown or discussed can be indirect coupling or communicative connection through some interfaces, apparatuses or units, and can be in electrical, mechanical or other forms.

This application is described with reference to the flowcharts and/or block diagrams of the method, the apparatus (system), and the computer program product based on the embodiments of this specification. It should be understood that computer program instructions can be used to implement each procedure and/or each block in the flowcharts and/or the block diagrams and a combination of a procedure and/or a block in the flowcharts and/or the block diagrams. These computer program instructions can be provided for a general-purpose computer, a dedicated computer, an embedded processor, or a processor of another programmable data processing device to generate a machine, so that the instructions executed by the computer or the processor of the another programmable data processing device generate an apparatus for implementing a specific function in one or more procedures in the flowcharts and/or in one or more blocks in the block diagrams.

These computer program instructions can also be stored in a computer-readable storage device that can guide a computer or another programmable data processing device to operate in a particular method, such that the instructions stored in the computer-readable storage device produce an article of manufacture including an instruction apparatus, and the instruction apparatus implements the functions specified in the one or more processes of the flowchart and/or the one or more boxes of the block chart.

The computer program instructions can alternatively be loaded onto a computer or another programmable data processing device, so that a series of operations and steps are performed on the computer or the another programmable device, so that computer-implemented processing is generated. Therefore, the instructions executed on the computer or the another programmable device provide steps for implementing a specific function in one or more procedures in the flowcharts and/or in one or more blocks in the block diagrams.

In a typical configuration, a computing device includes one or more processors (CPUs), one or more input/output interfaces, one or more network interfaces, and one or more memories.

The memory can include a form of a non-permanent storage device, a random access memory (RAM), and/or a nonvolatile memory, etc. in a computer-readable medium, such as a read-only memory (ROM) or a flash memory (flash RAM). The memory is an example of the computer-readable medium.

The computer-readable medium includes persistent, non-persistent, movable, and unmovable media that can store information by using any method or technology. The information can be computer-readable instructions, a data structure, a program module, or other data. Examples of the computer storage medium include but are not limited to a phase change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage, a graphene storage, another magnetic storage device, or any other non-transmission medium. The computer storage medium can be configured to store information that can be accessed by a computing device. Based on the definition in this specification, the computer-readable medium does not include transitory media such as a modulated data signal and carrier.

A person skilled in the art should understand that one or more embodiments of this specification can be provided as methods, systems, or computer program products. Therefore, the one or more embodiments of this specification can use a form of hardware only embodiments, software only embodiments, or embodiments with a combination of software and hardware. In addition, the one or more embodiments of this specification can use a form of a computer program product that is implemented on one or more computer-usable storage media (including but not limited to a disk storage device, a CD-ROM, an optical storage device, etc.) that include computer-usable program code.

The one or more embodiments of this specification can be described in the general context of computer-executable instructions executed by a computer, for example, a program module. Usually, the program module includes a routine, a program, an object, a component, a data structure, etc. for executing a specific task or implementing a specific abstract data type. The one or more embodiments of this specification can alternatively be practiced in distributed computing environments. In the distributed computing environments, tasks are executed by remote processing devices that are connected through a communication network. In the distributed computing environments, the program module can be located in both local and remote computer storage media including storage devices.

The embodiments of this specification are described in a progressive way. For the same or similar parts of the embodiments, mutual references can be made to the embodiments. Each embodiment focuses on a difference from other embodiments. Particularly, the system embodiments are basically similar to the method embodiments, and therefore are described briefly. For related parts, references can be made to some descriptions in the method embodiments. In the descriptions of this specification, descriptions of reference to terms such as “one or more embodiments”, “some embodiments”, “an example”, “a specific example”, or “some examples” mean that specific features, structures, materials, or characteristics described with reference to the embodiment or example are included in at least one embodiment or example of this specification. In this specification, illustrative expressions of the above-mentioned terms are not necessarily intended for the same embodiment or example. In addition, the described specific feature, structure, material, or characteristic can be combined in a proper manner in any one or more embodiments or examples. Moreover, a person skilled in the art can combine and associate different embodiments or examples and features of different embodiments or examples described in this specification, provided that the embodiments or examples and the features do not conflict with each other.

The above-mentioned descriptions are merely embodiments of the one or more embodiments of this specification, and are not intended to limit the one or more embodiments of this specification. A person skilled in the art knows that one or more embodiments of this specification can have various modifications and changes. Any modifications, equivalent replacements, improvements, etc. made without departing from the spirit and principle of this specification shall fall within the scope of the claims.

What is claimed is:

1. A computer-implemented method, applied to a first node in a blockchain system, wherein the first node comprises a control process and N computing processes, and the computer-implemented method comprises:
acquiring, by the control process, M transaction groups, wherein the M transaction groups are obtained by grouping a plurality of transactions in a target block based on respective pre-execution read-write sets of the plurality of transactions, and M and N are positive integers;
in response to determining that there is another block that is in an execution phase, acquiring, by the control process, a pre-execution read-write set of a transaction in the another block, and sending a transaction group among the M transaction groups that is irrelevant to the acquired pre-execution read-write set to different computing processes in the N computing processes; and
in response to receiving one of the M transaction groups, executing, by a first computing process, each transaction in the received transaction group.

2. The computer-implemented method according to claim 1, wherein the pre-execution read-write set of the transaction involves a contract parameter, wherein:
in the M transaction groups, transactions involving contract parameters of different contracts are divided into different transaction groups; and
when the acquired pre-execution read-write set involves a contract parameter of a first contract, the transaction group among the M transaction groups that is irrelevant to the acquired pre-execution read-write set comprises a transaction group that comprises a transaction not involving the contract parameter of the first contract.

3. The computer-implemented method according to claim 1, wherein:
a world state maintained by the blockchain system corresponds to a state trie, leaf nodes of the state trie comprise a contract account node and a plurality of contract parameter nodes,
wherein the contract account node is configured to record a contract account of a first contract deployed in the blockchain system,
the plurality of contract parameter nodes are each configured to record state values of different contract parameters in the first contract, and
update of the contract account node and update of the plurality of contract parameter nodes do not affect each other; and
the pre-execution read-write set of the transaction involves a contract parameter, and wherein:
in the M transaction groups, transactions involving different contracts or involving different contract parameters of a same contract are divided into different transaction groups; and
when the acquired pre-execution read-write set involves a contract parameter of the first contract, the transaction group among the M transaction groups that is irrelevant to the acquired pre-execution read-write set comprises a transaction group that comprises a transaction not involving the first contract or involving the first contract but not involving the contract parameter.

4. The computer-implemented method according to claim 3, wherein the first node further comprises a storage process; and the computer-implemented method further comprises:
sending, by the first computing process, a state value of the contract parameter to the storage process; and
updating, by the storage process based on the state value of the contract parameter, a state value recorded by a contract parameter node corresponding to the contract parameter in the state trie.

5. The computer-implemented method according to claim 3, wherein a state value of the contract parameter is recorded in a corresponding contract parameter node as a key-value pair, wherein a key of the contract parameter is calculated based on contract information of the first contract and parameter information of the contract parameter.

6. The computer-implemented method according to claim 3, wherein the contract account node does not record a value of a Storage_Root field.

7. The computer-implemented method according to claim 1, wherein the acquiring, by the control process, M transaction groups comprises:
acquiring, by the control process, the M transaction groups based on group information from a second node in the blockchain system.

8. The computer-implemented method according to claim 1, wherein:
the acquiring, by the control process, M transaction groups comprises: pre-executing, by the control process, the plurality of transactions, and dividing the plurality of transactions into the M transaction groups based on an obtained pre-execution read-write set; or
the first node further comprises a first consensus process; and the acquiring, by the control process, M transaction groups comprises: dividing, by the control process, the plurality of transactions into the M transaction groups based on the respective pre-execution read-write sets of the plurality of transactions received by the first consensus process from a second node in the blockchain system.

9. The computer-implemented method according to claim 8, wherein the dividing the plurality of transactions into the M transaction groups comprises:
determining a read-write set conflict relationship among the plurality of transactions based on the respective pre-executed read-write sets of the plurality of transactions;
determining a pre-and-post dependency relationship of at least some of the plurality of transactions based on the read-write set conflict relationship; and
grouping the plurality of transactions based on the pre-and-post dependency relationship to obtain the M transaction groups.

10. The computer-implemented method according to claim 1, further comprising:
concurrently executing, by the first computing process, transactions in a plurality of received transaction groups through a plurality of threads.

11. A computer-implemented method, applied to a first node in a blockchain system, wherein the first node comprises a control process and N computing processes, and the computer-implemented method comprises:
determining, by the control process, a plurality of blocks,
acquiring, by the control process, a transaction group corresponding to each of the plurality of blocks, wherein the transaction group is obtained by grouping a plurality of transactions in the corresponding block based on respective pre-execution read-write sets of the plurality of transactions;
generating, by the control process, a transaction group set, wherein transaction groups comprised in the transaction group set are from at least two of the plurality of blocks, and each of the transaction groups is irrelevant to a pre-execution read-write set corresponding to any other transaction group in the transaction group set; and
sending, by the control process, the transaction groups in the transaction group set to different computing processes in the N computing processes, wherein N is a positive integer; and
in response to receiving a transaction group, executing, by a first computing process, each transaction in the received transaction group.

12. A first node in a blockchain system, wherein the first node comprises one or more processors; and one or more tangible, non-transitory, machine-readable media storing one or more instructions that, when executed by the one or more processors, perform one or more processes comprising:
a control process and N computing processes, wherein:
the control process acquires M transaction groups, wherein the M transaction groups are obtained by grouping a plurality of transactions in a target block based on respective pre-execution read-write sets of the plurality of transactions, and M and N are positive integers;
in response to determining that there is another block that is in an execution phase, the control process acquires a pre-execution read-write set of a transaction in the another block, and sends a transaction group among the M transaction groups that is irrelevant to the acquired pre-execution read-write set to different computing processes in the N computing processes; and
in response to receiving any one of the M transaction groups, a first computing process executes each transaction in the received transaction group.

13. The first node according to claim 12, wherein the first computing process
concurrently executes transactions in a plurality of received transaction groups through a plurality of threads.

14. The first node according to claim 12, wherein:
a world state maintained by the blockchain system corresponds to a state trie,
leaf nodes of the state trie comprise a contract account node and a plurality of contract parameter nodes,
the contract account node is configured to record a contract account of a first contract deployed in the blockchain system,
the plurality of contract parameter nodes are each configured to record state values of different contract parameters in the first contract, and
update of the contract account node and update of the plurality of contract parameter nodes do not affect each other; and
the pre-execution read-write set of the transaction involves a contract parameter, wherein:
in the M transaction groups, transactions involving different contracts or involving different contract parameters of a same contract are divided into different transaction groups; and
when the acquired pre-execution read-write set involves a contract parameter of the first contract, the transaction group irrelevant to the acquired pre-execution read-write set among the M transaction groups comprises a transaction group that comprises a transaction not involving the first contract or involving the first contract but not involving the contract parameter.

15. The first node according to claim 14, wherein the one or more processes further comprise a storage process, wherein:
the first computing process sends a state value of the contract parameter to the storage process; and
the storage process updates, based on the state value of the contract parameter, a state value recorded by a contract parameter node corresponding to the contract parameter in the state trie.

16. The first node according to claim 14, wherein a state value of the contract parameter is recorded in a corresponding contract parameter node as a key-value pair, wherein a key of the contract parameter is calculated based on contract information of the first contract and parameter information of the contract parameter.

17. The first node according to claim 14, wherein the contract account node does not record a value of a Storage_Root field.

18. The first node according to claim 12, wherein:
the control process acquires the M transaction groups by: pre-executing, by the control process, the plurality of transactions, and dividing the plurality of transactions into the M transaction groups based on an obtained pre-execution read-write set.

19. The first node according to claim 18, wherein the dividing the plurality of transactions into the M transaction groups comprises:
determining a read-write set conflict relationship among the plurality of transactions based on the respective pre-executed read-write sets of the plurality of transactions;
determining a pre-and-post dependency relationship of at least some of the plurality of transactions based on the read-write set conflict relationship; and
grouping the plurality of transactions based on the pre-and-post dependency relationship to obtain the M transaction groups.

20. The first node according to claim 12, wherein:
the one or more processes further comprise a first consensus process; and
the control process acquires the M transaction groups by: dividing the plurality of transactions into the M transaction groups based on the respective pre-execution read-write sets of the plurality of transactions received by the first consensus process from a second node in the blockchain system.
